(19) United States
(12) Patent Application Publication
(10) Pub. No.: US 2010/0192533 A1
(43) Pub. Date: Aug. 5, 2010

(54) TURF TREATMENT APPARATUS WITH FLOATING HEAD SUSPENDED FROM A FRAME

(76) Inventors: John Coleman, Sheffield (GB); John Henry Turner, Nottinghamshire (GB)

Correspondence Address: MESCHKOW & GRESHAM, P.L.C., 7250 NORTH SIXTEENTH STREET, SUITE 318, PHOENIX, AZ, 85020-5279, US

(21) Appl. No.: 12/362,951

(22) Filed: Jan. 30, 2009

(51) Int. Cl. A01D 34/00; A01D 34/835

(52) U.S. Cl. 56/15.8; 56/292

(57) ABSTRACT

A turf treatment apparatus with a floating head for use on a grass treatment device having a frame, the turf treatment apparatus having a floating head comprising at least one elongate grass treatment element, and a mounting configured to effect a floating action with respect to the frame wherein the mounting comprises at least one resilient spring element that is configured to spread the weight of the grass treatment element by virtue of the resilience of the at least one spring element acting to counter the force of gravity arising during use of the floating head on non horizontal terrain.

### FIELD OF THE INVENTION

The present invention relates to an improved floating head mechanism for a turf treatment apparatus. More particularly, but not exclusively, the present invention relates to an improved floating head mechanism that allows the self adjustment of a cutting head and associated rollers relative to a ground surface on a hand mower.

### BACKGROUND TO THE INVENTION

Typically mowers, particularly of the walk reel type comprise a frame, typically made of aluminum, attached to which is a grass treatment head that comprises a cutting tool and/or one or more other tools such as a groomer. The terms “grass” and “turf” are to be construed herein as synonymous as used in relation to the terms “grass treatment device” and “turf treatment apparatus”. An example of such a device/apparatus is a mower of the walk reel type or a mower of the three-wheeled sit-down type. It is important that the grass treatment head unit of a lawn mower or other type of grass treatment device is capable of movement relative to the surface upon which it is placed and which it is configured to treat. Prior art mowers where the grass treatment head is rigidly attached to the frame of the mower are known as for example is disclosed in U.S. Pat. No. 5,477,666 to Cotton or U.S. Pat. No. 4,481,757 to Tsuchiya. Rather than a rigid connection between the frame and the treatment head it is desirable to enable the head to move relative to the frame. This is in large part due to the very serious consequences of permanent damage that may occur to the grass surface if the cutting treatment head cuts too deeply into it. Where the entirety of the grass is removed from the grass surface, this is known as scalping, and in the case of golf courses such scalping can have very serious implications for the usability of a particular course, hole or green.

Previously several mechanisms have been developed to allow the cutting/treatment head to independently adapt or float with respect to a ground surface and the body of the device to which it is attached.

In particular, prior art devices have been provided which are connected to the cutting head via a set of chains or other flexible linkage system. An example of such a mechanism is disclosed in U.S. Pat. No. 2,972,218. In such a mechanism the chains allow the head to move relative to the body and surface upon which it is acting. The head can move freely up to and including the fullest extension of the chain. This connection means has a significant disadvantage however, as the head can move in an uncontrolled manner, particularly during sudden or unexpected movements of the head, body or changes in the ground surface.

An alternative means of linking the treatment head to the main body or frame of a grass treatment device, such as a mower, is the provision of a four bar linkage mechanism, connecting the cutting head of the device to the main body. An example of such a mechanism is disclosed in US patent application publication no. US 2002/0095922 A1. Such a four bar linkage mechanism allows the cutting head to move in a single plane relative to the main body. This is because this fixation method is less flexible than the aforementioned chain type approach in that the cutting head responds to changes in the topography of the underlying terrain in a more predictable and reproducible fashion. Disadvantages exist however with this prior art coupling method as limitations of movement in this single plane make it difficult sometimes to prevent the scalping of uneven surfaces with such a device.

The scalping of grass surfaces is a significant problem as the damaging of a grass surface can render it entirely unsuitable for its use as a playing surface.

Features and safety measures which decrease the likelihood of scalping or damage to a grass surface are desirable to the grass turf maintenance industries. Damage resulting from such injuries to a grass surface can be compounded if a relatively inexperienced operator uses a device which as previously explained has a great deal of leeway or unpredictability in the way in which the floating head of the treatment device will react in different situations. Therefore, by minimizing the degree of self adjustment which the floating head mechanism is capable of performing, this will minimize the chances of potential damage from scalping incidents by even the most inexperienced operator of such a device.

Another problem associated with prior art coupling methods arises when vertical cuts are made into a surface. If such cuts are made with a device using a chain or other linkage system, due to the uncontrolled nature or orientation of the cutting blades the cuts can be widened due to movement of the blades mid-cut. This can damage the surface and lead to gapping in the surface allowing soil diseases and other unwanted materials into the delicate soil strata.

### SUMMARY OF THE INVENTION

An object of the present invention is to provide a floating head mechanism for a grass treatment device, such as a mower, that permits a greater degree of control of the grass treatment element and thus minimizes damage to a grass surface.

Another object of the present invention is to provide a mounting for a floating head of a mower that utilizes no moving parts as such.

According to a first aspect of the present invention there is provided a floating head apparatus for use on a grass treatment device such as a mower having a frame, said floating head apparatus comprising:
at least one elongate grass treatment element, such as a grass cutting tool; and
a mounting configured to effect said floating action with respect to said frame,
wherein said mounting comprises at least a first resilient spring element that is configured to spread the weight of said grass treatment element by virtue of the resilience of said spring element acting to counter the force of gravity arising during use of said floating head on none horizontal terrain.

Preferably said at least one spring element is in the form of a leaf spring.

Preferably said at least one resilient spring element comprises a substantially planar member.

Preferably said at least one spring element is made of spring steel.

Preferably said apparatus comprises first and second resilient spring elements, each said spring element configured to spread the weight of said grass treatment element.

According to a second aspect of the present invention there is provided a floating grass treatment head apparatus for use on a grass treatment device such as a mower comprising a frame, said floating head apparatus comprising:
at least one elongate grass treatment element, such as a grass cutting tool, occupying a first plane; and
a mounting configured to effect said floating action with respect to said frame,
wherein said mounting comprises first and second resilient spring elements, said spring elements configured to spread the weight of said grass treatment element by virtue of the resilience of said spring elements acting to counter the force of gravity arising during use of said floating head on none horizontal terrain.

Preferably said first and second resilient spring elements are located substantially above said grass treatment element and at the rest position of said apparatus act in respective first and second planes that intersect the respective spring elements and the longitudinal axis of said floating head apparatus.

Preferably said first and second resilient spring elements are located substantially above said grass treatment element and at the rest position of said apparatus act in respective first and second planes that intersect the respective spring elements and the longitudinal axis of said floating head apparatus and said first and second planes are substantially parallel to said longitudinal axis.

Preferably said first and second resilient spring elements are located substantially above said grass treatment element and at the rest position of said apparatus act in respective first and second planes that intersect the respective spring elements and the longitudinal axis of said floating head apparatus and said first and second planes are substantially parallel to said longitudinal axis and said second spring element occupies a third plane that is transverse to said second plane occupied by said second spring element.

Preferably said first and second resilient spring elements, at the rest position of said apparatus, act in respective first and second planes that intersect at the longitudinal axis of said floating head apparatus.

Preferably said first and second resilient spring elements, at the rest position of said apparatus, act in respective first and second planes that intersect at the longitudinal axis of said floating head apparatus, the angle subtended by said intersection being approximately 45 degrees.

Preferably said first spring element and said second spring element collectively work to oppose motion of said apparatus when said apparatus moves due to being located on a slope.

According to a third aspect of the present invention there is provided mounting configured to connect a floating head apparatus to the frame of a grass treatment device, such as a mower, wherein:
said mounting comprises at least a first resilient spring element.

Preferably said at least one spring element is in the form of a leaf spring.

Preferably said at least one leaf spring comprises a substantially planar member.

Preferably said at least one spring element is made of steel.

Preferably said resilient spring element substantially comprises a rectangular shaped steel plate.

Preferably said resilient spring element substantially comprises a rectangular shaped plate having no cutout sections.

Preferably aid resilient spring element substantially comprises a rectangular shaped plate having at least one cutout section.

Preferably said mounting comprises first and second resilient spring elements configured to work to collectively adjust the weight distribution across a floating head apparatus that is tilted from the horizontal.

According to a fourth aspect of the present invention there is provided a floating head apparatus comprising a mounting for attaching said head to a frame of a mower, said mounting comprising first and second leaf spring elements.

Preferably said leaf spring elements are substantially planar members.

According to a fifth aspect of the present invention there is provided a turf treatment apparatus comprising a floating head treatment unit wherein said floating head is suspended from a frame of said apparatus by at least one substantially planar spring element, said element responsive to changes in (a) the motion of said mower and (b) the topography of the terrain under said mower.

Preferably said mower comprises first and second spring elements to suspend said floating head.

Preferably said at least one spring element functions in response to torsional forces acting on said floating head.

Preferably said turf treatment apparatus is a walk reel mower.

Preferably said turf treatment apparatus is a mower having a seat for an operator to sit on and thereby drive said mower.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1A schematically illustrates, in front elevation view a mower with grass box and covers removed, having a floating head apparatus as configured in accordance with a preferred embodiment of the present invention;

FIG. 1B schematically illustrates the same mower 101 with covers and a grass box in place;

FIG. 2 further details, in perspective view, the floating head mechanism and part of the frame of the mower of FIGS. 1A and 1B;

FIG. 3 further schematically illustrates in front elevation view the floating head mechanism of FIGS. 1A, 1B and FIG. 2;

FIGS. 4, 5 and 6 schematically illustrate in front elevation view the workings of the floating head mechanism on horizontal terrain (FIG. 4) and on tilting due to the floating head being used on inclined terrain (FIGS. 5 and 6);

FIG. 7 schematically illustrates a second preferred embodiment of mounting a floating head grass treatment apparatus in accordance with the present invention;

FIG. 8 further schematically details, in perspective view, the mounting assembly of FIG. 7;

FIG. 9 further schematically details, in front elevation view, the mounting assembly of FIGS. 7 and 8; and

FIG. 10 further details schematically, in perspective view, the mounting assembly of FIGS. 7, 8 and 9.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

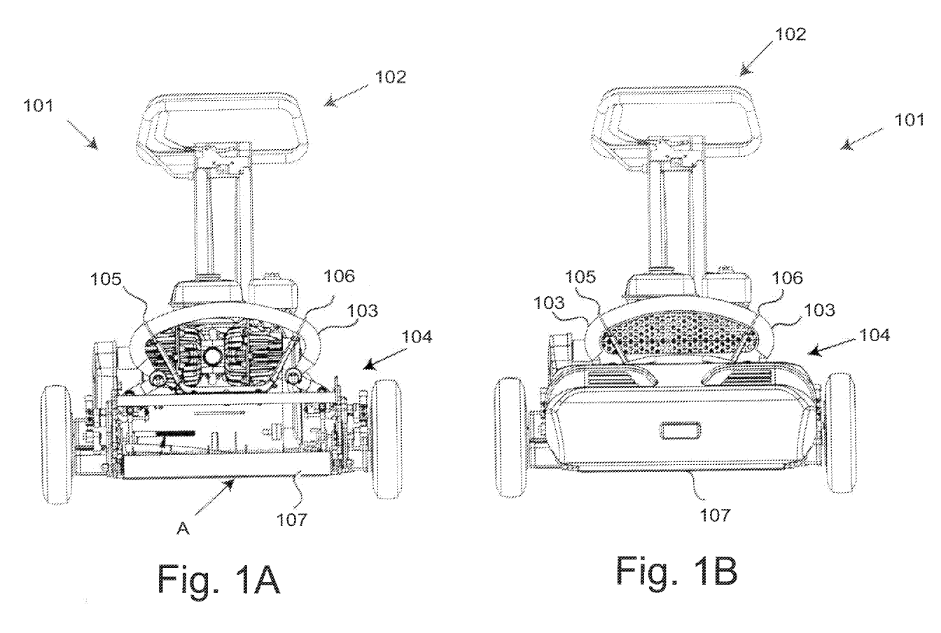

FIG. 1A schematically illustrates, in front elevation view, a mower 101, with grass box and covers removed, having a floating head apparatus as configured in accordance with a preferred embodiment of the present invention. FIG. 1B schematically illustrates the same mower 101 with covers and a grass box in place. Mower 101, of the type pushed by hand, comprises a handle and operational portion generally indicated at 102, a main frame 103 attached to the handle and also to an engine and wheel assembly and at the front of the mower a floating grass treatment head 104 comprising a grass treatment tool or element (for example a cutting unit) and a roller assembly. In accordance with the present invention grass treatment head 104 is attached, that is mounted, to main frame 103 via one or more mountings 105, 106. Mountings 105, 106 each comprise a leaf spring element that is configured to spread the weight of the grass treatment element by virtue of the resilience of the spring element acting to counter the force of gravity arising during use of the floating grass treatment head on none horizontal terrain. In this respect such a leaf spring may be considered to act as a torsion spring. Finally as illustrated in FIGS. 1A and 1B grass treatment head 104 comprises a front roller assembly 107. Cylindrical roller 107 has a longitudinal axis running along it length (from left to right across the page) and a height defined by the diameter of the circular ends of the roller. The length of the longitudinal axis of the roller, or the treatment tool, more or less defines the width of the mower (the width being the distance from one side of the mower to the other, that is from left to right across the page in FIG. 1A).

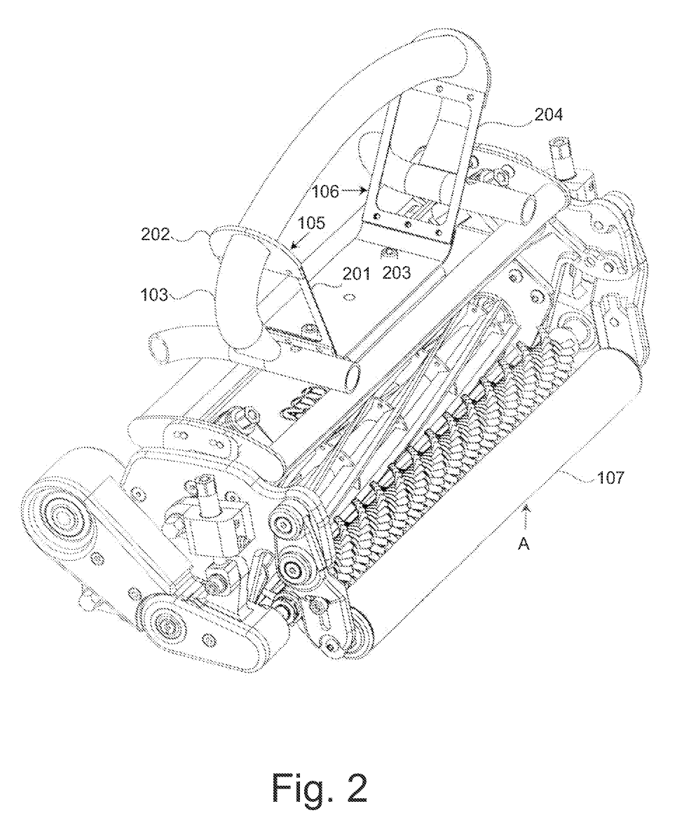

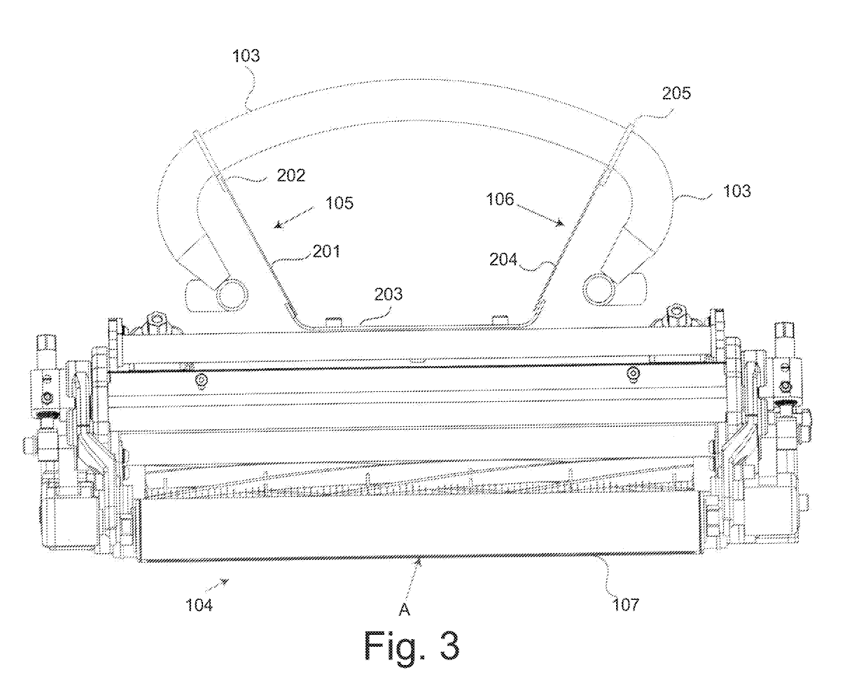

FIG. 2 further schematically illustrates in perspective view the floating head mechanism 104 of FIGS. 1A and 1B as configured in accordance with a preferred embodiment of the present invention. FIG. 3 schematically illustrates in front elevation view the floating head mechanism of FIGS. 1A and 1B and FIG. 2.

Floating head mechanism 104 is configured with a dynamic return design feature that is configured to constantly attempt to restore the weight of the treatment head evenly across the width of the head when a mower comprising the treatment head is being used on terrain that is not perfectly horizontal. Importantly in accordance with the treatment head attachment mechanism provided by the present invention wear of and maintenance of the mechanism is, in contrast to prior art mechanisms, minimized by virtue of there being no moving parts as such. In essence the floating head 104 is configured to constantly self-correct its orientation with respect to the surface of the terrain underneath so that it is substantially always parallel to the surface.

Mountings 105, 106 are more clearly illustrated in FIGS. 2 and 3. Mounting 105 mainly comprises a leaf spring element 201 that is attached to frame 103 via an attachment mechanism 202. In the embodiment shown attachment mechanism 202 simply comprises a bolted fastening that encircles a portion of frame 103. Mounting 105 further comprises an attachment mechanism 203 for connecting leaf spring 201 to the grass treatment head. In common with mounting 105, mounting 106 also comprises a leaf spring element 204 that is attached to frame 103 via a bolted attachment mechanism 205. Similarly leaf spring 204 is connected to the grass treatment head via bolted attachment assembly 203. Those skilled in the art will appreciate that the means of fixing the leaf springs in place may take a variety of forms and the bolted mechanisms disclosed are given by way of example only.

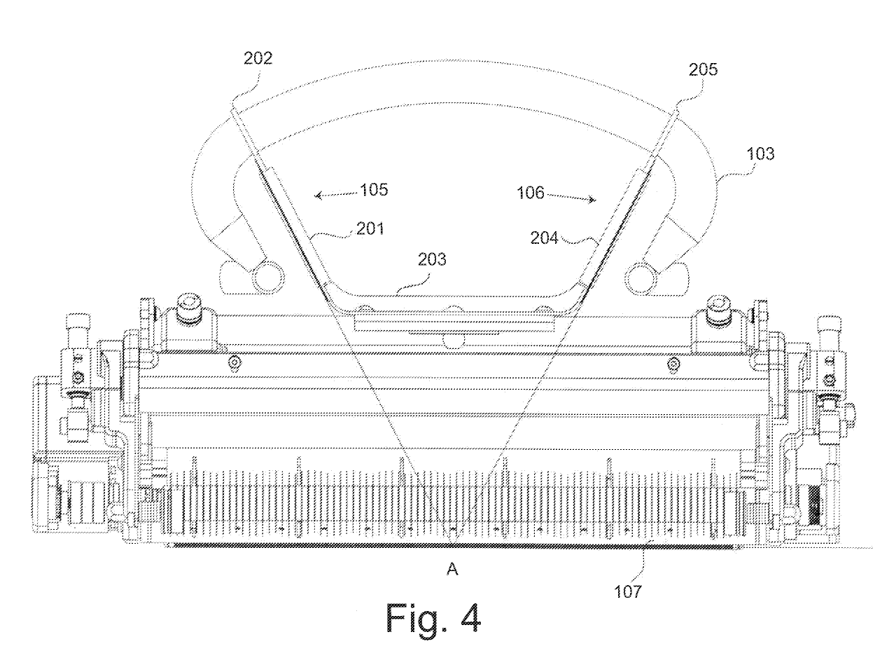

In order to describe the function of the mounting assemblies 105, 106 it is necessary to define certain directions. Referring to FIGS. 1A and 1B, FIG. 2 and FIG. 3 front roller assembly 107 defines a first direction (from left to right across the page) that represents the direction of the longitudinal axis of the roller. Perpendicular to the longitudinal axis of the roller, that is in a direction directly into the page, lies the longitudinal axis of the mower itself (in other words the line through the center of the mower passing from the back of the mower to the front of the mower and thereby intersecting the front roller 107 at 90 degrees to the longitudinal axis of roller 107. Thus the longitudinal axis of the mower also represents the longitudinal axis of the floating head device 104 and thus is directed in a direction that is 90 degrees to the longitudinal axis of roller 107. From FIGS. 1A, 1B, FIG. 2 and FIG. 3 it is seen that the respective leaf spring elements 201, 204 of respective mountings 105, 106 are configured such that they are substantially planar members that lie in planes that are parallel to the longitudinal axis of the mower and therefore of floating head 104. The plane occupied by spring element 105 is thus at 90 degrees to the direction of the longitudinal axis of roller 107. Likewise the plane occupied by spring element 106 is also disposed at 90 degrees to the direction of the longitudinal axis of roller 107. Furthermore the leaf spring elements 201, 204 are configured such that when floating head 104 is on horizontal ground the respective planes that each element occupies intersect at the base of the floating head apparatus such as is indicated at the point “A” on roller assembly 107. Point “A” is the midway point along the longitudinal axis of the front roller and thus this point also lies on the longitudinal axis of the mower. When the mower is at rest it is meant herein that the mower is on perfectly horizontal ground. When on such ground spring elements 201 and 204 define planes that intersect at point “A”. However when the floating head 104 is tilted the planes occupied by the spring elements 201, 204 no longer intersect at point “A”, but at a shifted position away from the longitudinal axis of the mower. The reason for the shift is due to the spring elements 201, 204 having compensated for the non-horizontal terrain on which the mower is located. This is more clearly illustrated in FIGS. 4, 5 and 6.

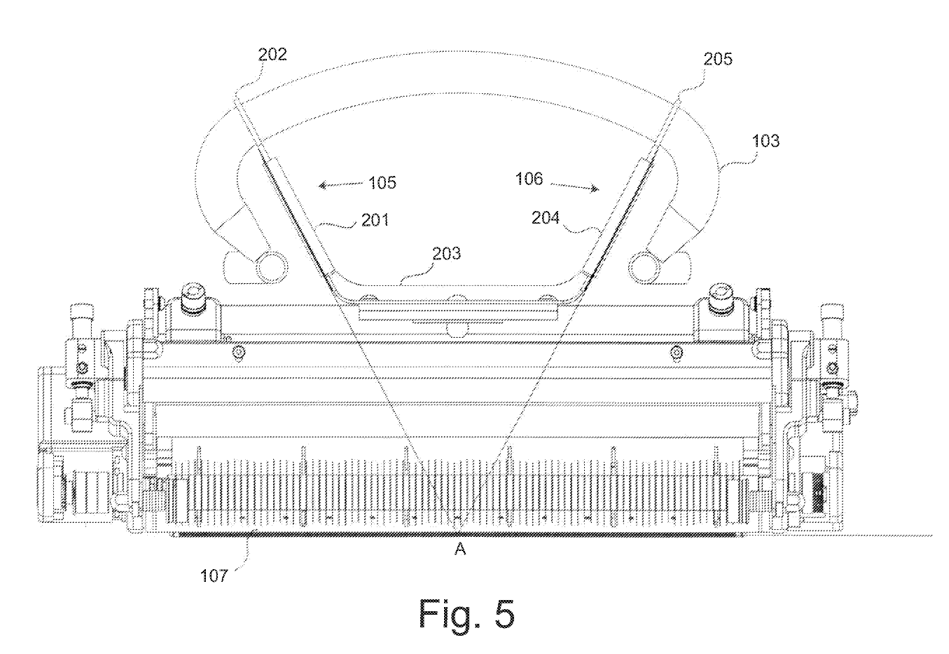

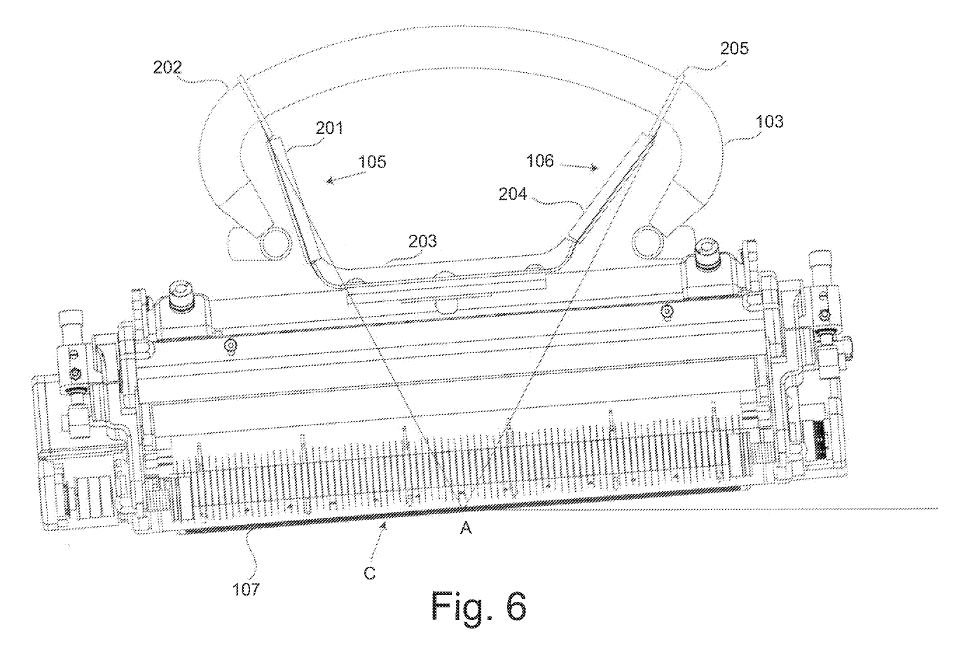

FIGS. 4, 5 and 6 schematically illustrate in front elevation view the workings of the floating head mechanism of FIGS. 1A, 1B, FIG. 2 and FIG. 3 on horizontal terrain (FIG. 4) and on tilting due to the floating head being used on inclined terrain (FIGS. 5 and 6).

FIG. 4, in front elevation view, further schematically illustrates the grass treatment head 104 of the earlier figures. Grass treatment head device 104 is illustrated as being on horizontal ground and therefore the planes occupied by respective leaf spring elements 201, 204 of respective mountings 105, 106 intersect at point “A”, that is the point directly below the leaf spring elements that lies on the longitudinal axis through the mower and hence through the floating head 104. The angle subtended at point “A” by the pair of spring elements 201, 204 is 45 degrees and this arrangement is herein referred to as the rest or equilibrium position of the treatment head 104. The reason that the spring elements are each orientated at 45 degrees to the horizontal and effectively point towards each other is so that the pivot point of the treatment tool, for example a grass cutting reel, is at the mid point along its longitudinal axis (i.e. at its center). Furthermore, as those skilled in the art will appreciate, the pivot point should be such that it is as close to the base of the treatment tool as possible, that is a close to the lower edge of the treatment tool as possible. This arrangement minimizes “swing” of the floating head mechanism when a given mower comprising such a floating head is traversing contours. Although other angles around 45 degrees may provide a useful working floating head arrangement the preferred angle is exactly 45 degrees.

FIG. 5 further schematically illustrates the arrangement shown in FIG. 4, but wherein the floating head 104 is located on terrain that is not horizontal, but slopes from left to right across the page. Because of the slope or gradient of the underlying terrain the leaf spring elements 201, 204 respond and compensate in response to the change in the center of gravity of the grass treatment head. The gradient of the plane occupied by spring element 201 on the upper part of the slope effectively lessens whilst the gradient of the slope of spring element 204 on the lower part of the slope effectively increases. The point of intersection of the mounting attachments 202, 205 remains the same at point “A”, but the point of intersection of the planes occupied by respective spring elements 201, 204 have, due to the sloping terrain, shifted to the right to point “B”.

The opposite situation to that shown in FIG. 5 is schematically illustrated in FIG. 6 wherein floating head 204 is located on non-horizontal terrain that slopes from the right to the left of the page (i.e. the slope is in the opposite direction to that shown in FIG. 5). Thus the terrain is higher to the right side of the page and leaf spring elements 201, 204 respond accordingly. Again the point of intersection of the planes occupied by the leaf spring elements 201, 204 has been shifted relative to point “A” such that it now occupies point “C” to the left of Point “A”.

FIGS. 4, 5 and 6 thus clearly illustrate the compensatory effects of leaf spring elements 201, 204 that respectively form part of mountings 105 and 106. Any tilting of the mower is compensated by these leaf springs such that the weight of the floating head is more evenly distributed across its width, that is in a direction along the longitudinal axis of front roller 107. The greater the gradient of the slope that the mower is located on with its longitudinal axis substantially parallel to a contour defining the slope the greater the amount of swing of the floating head. In other words when the mower is traversing a slope in parallel to the contours defining the gradient the greater the force acting on and thereby displacing the spring elements from their equilibrium position. Thus the greater the distance that arises between point B (or point C, when the mower is traversing in the opposite direction across the same sloping terrain) from point A.

As those skilled in the art will appreciate the leaf spring elements 201, 204 may take a variety of forms. In the best mode contemplated they are made of spring steel and of a sufficient resilience to provide the required compensatory effects on a given floating head tilting on none-horizontal terrain. The exact configuration of the springs themselves may take a variety of planar forms. They may suitably comprise a plate with or without any holes being incorporated therein. However in the best mode contemplated and as shown in FIGS. 2 and 3 they are substantially rectangular with the central region cutout so as to enhance the compensation effect. Unlike the prior art mechanisms described earlier these leaf spring elements do not have any moving parts as such since they merely flex and thus act as torsion elements. In contrast the aforementioned prior art chain and four bar linkage mechanisms all involve mechanically pivoting one mechanical element against another.

The preferred embodiment of the present invention hereinbefore described comprises mounting a floating head by using a first mounting point located at one side of the floating head and a second mounting point located at the other side of the floating head. The respective mountings have been illustrated as separate entities as this represents the best mode contemplated. However they could both be realized by a single member of spring element material such that each end functions in the same way as two separate elements. In this regard a single such member is functionally equivalent to two separate members and is thus to be considered merely as a variant of the present invention.

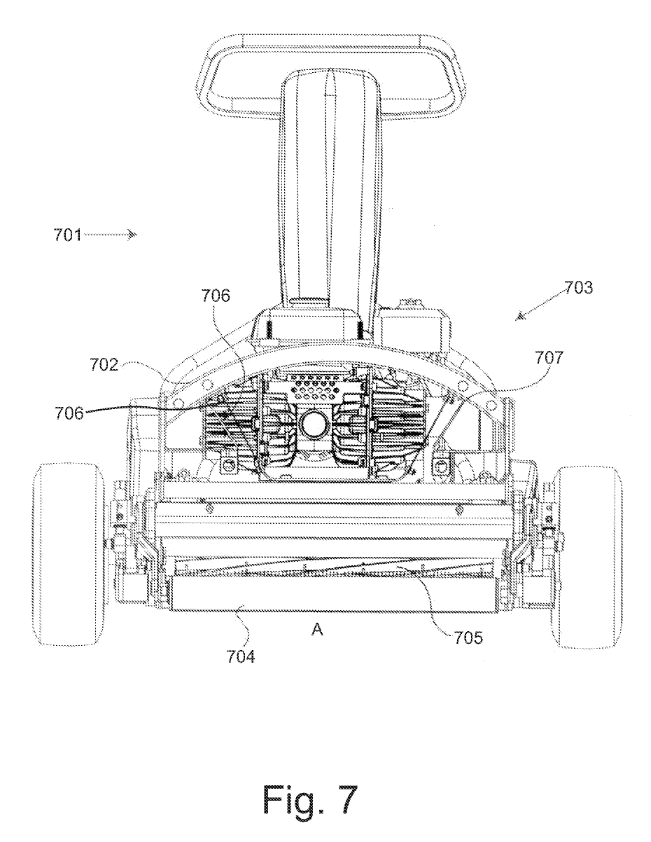

In accordance with the present invention FIG. 7 schematically illustrates a second preferred embodiment of mounting a floating head on a grass treatment device such as a mower. Mower 701 is essentially the same as that disclosed in FIG. 1A. Mower 701 thus comprises a frame 702 for mounting a floating head grass treatment unit that is generally indicated at 703. Floating head unit 703 comprises a roller 704 and one or more grass treatment tools (for example a cutter and/or a groomer) as indicated at 705.However the mounting assembly of mower 701 has been modified slightly relative to that of the earlier embodiment of FIGS. 1-6. The mounting assembly comprises mountings 706 and 707 that in common with the mountings of the previous embodiment each respectively comprise a leaf spring element. However the arrangement for attaching each leaf spring element to the frame 702 differs to that of the previous embodiment. Notwithstanding this difference the geometry of the mower in its rest or equilibrium position and on inclined terrain is substantially the same as described above in relation to the previous embodiment and thus point “A” indicated at the center point along roller 704 corresponds to Point A of FIGS. 1-6.

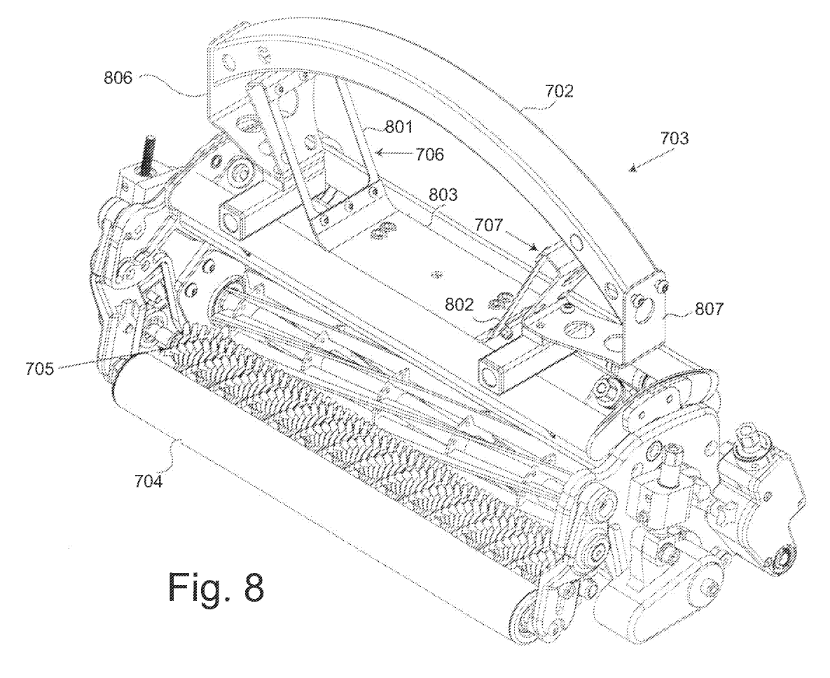

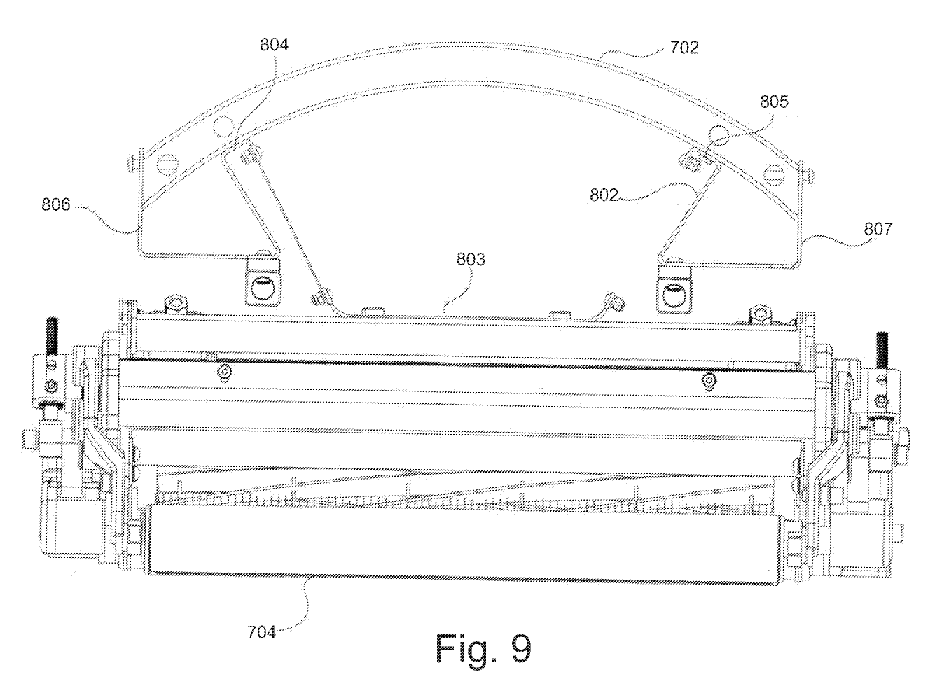

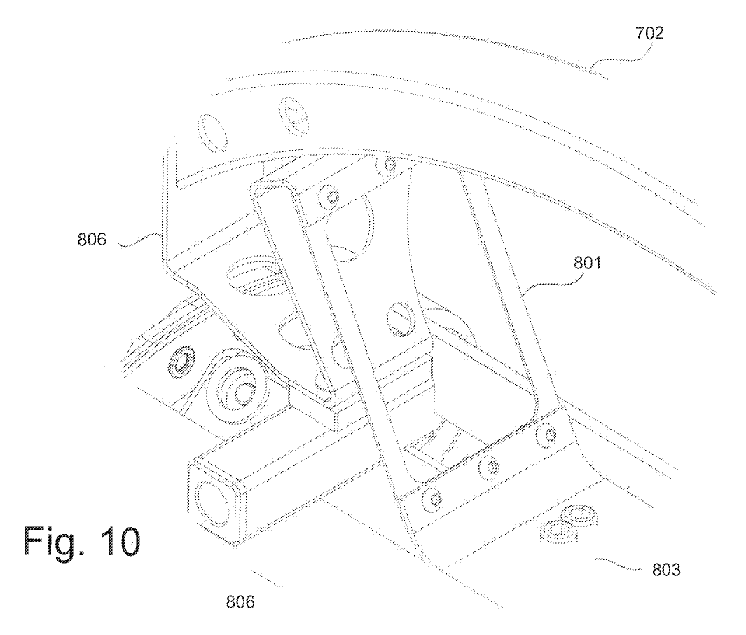

FIG. 8 further schematically details, in perspective view, the mounting assembly of FIG. 7. This figure more clearly shows the incorporation of a groomer and a grass cutter immediately behind the groomer. FIG. 9 further schematically details, in front elevation view, the mounting assembly of FIGS. 7 and 8 and FIG. 10 further details schematically, in perspective view, the mounting assembly of FIGS. 7, 8 and 9.

The main aspect of concern in FIGS. 8 to 10 is that of the mounting arrangement for mounting the floating head to arcuate frame 702. Torsion spring elements 801 and 802 are substantially as described in relation to FIGS. 1-6. However the attachment of these respective spring elements to arcuate frame 702 is to the underside of frame 702 via respective bolts 804, 805. As before the spring elements are fixed to the remainder of the floating head 703 via bolting to a base plate 803. As those skilled in the art will readily appreciate certain other features shown in FIGS. 7-10 relate to simplifying manufacture of the floating head unit. For example the assemblies located to wards the ends of the arcuate frame member 702 comprise steel plates that ease manufacture of the device in relation to the matter of engaging a grass cutter box.

Those skilled in the art will appreciate that tin accordance with the present invention the use of one or more spring elements, preferably two, to suspend a floating head mechanism on a grass treatment device provides many benefits as compared with prior art mechanisms. The mechanism is easy to maintain since no mechanical moving parts as such are involved. In other words there are no pivots involved, the only movement that occurs is that of the flexing of the spring elements themselves. Such flexing may occur in three dimensions from a simple bending of the planar spring elements out of their normal planar configuration to a more complex bending and/or twisting of their normally planar configuration. Of course the degree of bending and or twisting is dictated from one moment to another as a given mower comprising such elements traverses the terrain of, for example, a golf course. The main factors affecting the bending/twisting are:
the topography underneath the mower at any given instant and in particular the gradient thereof; and
the direction of movement of the mower from one moment to another as determined by an operator of the mower which causes centrifugal forces to arise and be responded to by the spring elements as well as changes in the resultant gravitational force experienced by each part of the floating head mechanism.

1. A floating head apparatus for use on a grass treatment device having a frame, said floating head apparatus comprising:
at least one elongate grass treatment element; and
a mounting configured to effect a floating action with respect to said frame,
wherein said mounting comprises at least one resilient spring element that is configured to spread the weight of said grass treatment element by virtue of the resilience of said at least one spring element acting to counter the force of gravity arising during use of said floating head on non horizontal terrain.

2. A floating head apparatus as claimed in claim 1 wherein said at least one resilient spring element is in the form of a leaf spring.

3. A floating head apparatus as claimed in claim 2 wherein said at least one resilient spring element comprises a substantially planar member.

4. A floating head apparatus as claimed in claim 1 wherein said at least one resilient spring element is made of spring steel.

5. A floating head apparatus as claimed in claim 1 wherein said apparatus comprises said at least one resilient spring element and a second resilient spring element, each said spring element configured to spread the weight of said grass treatment element.

6. A floating grass treatment head apparatus for use on a grass treatment device in the form of a mower comprising a frame, said floating head apparatus comprising:
at least one elongate grass treatment element; and
a mounting configured to effect a floating action with respect to said frame,
wherein said mounting comprises first and second resilient spring elements, said spring elements configured to spread the weight of said grass treatment element by virtue of the resilience of said resilient spring elements acting to counter the force of gravity arising during use of said floating head apparatus on non horizontal terrain.

7. A floating head apparatus as claimed in claim 6 wherein said first and second resilient spring elements are located substantially above said grass treatment element and at the rest position of said apparatus act in respective first and second planes that intersect said respective resilient spring elements and the longitudinal axis of said floating head apparatus.

8. A floating head apparatus as claimed in claim 6 wherein said first and second resilient spring elements are located substantially above said grass treatment element and at the rest position of said apparatus act in respective first and second planes that intersect said respective resilient spring elements and the longitudinal axis of said floating head apparatus and said first and second planes are substantially parallel to said longitudinal axis.

9. A floating head apparatus as claimed in claim 6 wherein said first and second resilient spring elements are located substantially above said grass treatment element and at the rest position of said apparatus act in respective first and second planes that intersect said respective resilient spring elements and the longitudinal axis of said floating head apparatus and said first and second planes are substantially parallel to said longitudinal axis and said second spring element occupies a third plane that is transverse to said second plane occupied by said second spring element.

10. A floating head apparatus as claimed in claim 6 wherein said first and second resilient spring elements, at the rest position of said apparatus, act in respective first and second planes that intersect at the longitudinal axis of said floating head apparatus.

11. A floating head apparatus as claimed in claim 6 wherein said first and second resilient spring elements, at the rest position of said apparatus, act in respective first and second planes that intersect at the longitudinal axis of said floating head apparatus, the angle subtended by said intersection being approximately 45 degrees.

12. A floating head apparatus as claimed in claim 6 wherein said first spring element and said second spring element collectively work to oppose motion of said apparatus when said apparatus moves due to being located on a slope.

13. A mounting configured to connect a floating head apparatus to the frame of a grass treatment device, such as a mower, wherein:
said mounting comprises at least a first resilient spring element.

14. A mounting as claimed in claim 13 wherein said at least one spring element is in the form of a leaf spring.

15. A mounting as claimed in claim 13 wherein said at least one leaf spring comprises a substantially planar member.

16-18. (canceled)

19. A mounting as claimed in claim 13 wherein said resilient spring element substantially comprises a rectangular shaped plate having at least one cutout section.

20. A mounting as claimed in claim 13 comprising first and second resilient spring elements configured to work to collectively adjust the weight distribution across a floating head apparatus that is tilted from the horizontal.

21. A floating head apparatus comprising a mounting for attaching said head to a frame of a mower, said mounting comprising first and second leaf spring elements.

22. A floating head apparatus as claimed in claim 21 wherein said leaf spring elements are substantially planar members.

23. A turf treatment apparatus comprising a floating head wherein said floating head is suspended from a frame of said apparatus by at least one substantially planar spring element, said at least one substantially planar spring element responsive to changes in (a) motion of said mower and (b) topography of the terrain under said mower.

24. A turf treatment apparatus as claimed in claim 23 wherein said apparatus comprises said at least one substantially planar spring element and a second spring element to suspend said floating head.

25. A turf treatment apparatus as claimed in claim 23 wherein said at least one substantially planar spring element functions in response to torsional forces acting on said floating head.

26. A turf treatment apparatus as claimed in claim 23 wherein said apparatus comprises a walk reel mower.

27. A turf treatment apparatus as claimed in claim 23 wherein said apparatus comprises a mower, said apparatus having a seat for an operator to sit on and thereby drive said apparatus.

28. A turf treatment apparatus as claimed in claim 23 wherein said at least one substantially planar spring element occupies a plane that intersects a longitudinal axis of said floating head.

29. A turf treatment apparatus as claimed in claim 23 wherein when said turf treatment apparatus is located on horizontal ground, said at least one substantially planar spring element substantially intersects a longitudinal axis of said turf treatment apparatus.

30. A turf treatment apparatus as claimed in claim 23 wherein said apparatus comprises said at least one substantially planar spring element and a second substantially planar spring element, each of said spring elements being resilient and configured to adjust the weight distribution across said floating head when said floating head is tilted from the horizontal.
